(19) United States
(12) Patent Application Publication
(10) Pub. No.: US 2024/0213713 A1
(43) Pub. Date: Jun. 27, 2024

(54) CONNECTOR AND CONNECTOR SYSTEM

(71) Applicant: FIT VOLTAIRA GROUP GMBH, Pfullingen (DE)

(72) Inventors: Jürgen DETTINGER, Pfullingen (DE); Jürgen MENTZEL, Pfullingen (DE); Markus METZGER, Pfullingen (DE); Carolin KORTSCHIK, Pfullingen (DE); David SIWEK, Pfullingen (DE); Matthias OEHRLE, Pfullingen (DE)

(21) Appl. No.: 18/598,687

(22) Filed: Mar. 7, 2024

Related U.S. Application Data
(63) Continuation of application No. PCT/EP2022/072981, filed on Aug. 17, 2022.

(30) Foreign Application Priority Data
Sep. 13, 2021 (DE) 10 2021 123 660.6

(51) Int. Cl. H01R 13/627

(52) U.S. Cl. CPC H01R 13/6277; H01R 13/6278

(57) ABSTRACT

A connector with a base body which encloses a cavity between a first opening and a second opening. The base body is configured such that at least one cable can be guided through the first opening, the cavity and the second opening, wherein at least two bars are arranged on a circumference of the first opening, wherein a spring segment is arranged at least between two bars which are adjacent along the circumference and a total of at least two spring segments are present. An outwardly pointing protrusion is arranged on each spring segment, wherein each spring segment is configured such that it deforms elastically inwards against a spring force when pressure acts on the protrusion from outside, so that the protrusion can displace inwards, and that it can displace the protrusion outwards by the spring force when the pressure is removed.

### CROSS-REFERENCES TO RELATED APPLICATIONS

This application is a continuation of international patent application PCT/EP2022/072981, filed on 17 Aug. 2022 designating the U.S., which international patent application has been published in German language and claims priority from German patent application 10 2021 123 660.6, filed on 13 Sep. 2021. The entire contents of these priority applications are incorporated herein by reference.

### BACKGROUND

The present invention relates to a connector and connector system.

Connectors and connector systems play a major role in today's product manufacturing. They enable different product parts to be manufactured separately and then connected together by plugging them into each other. Connectors and connector systems are particularly interesting with regard to assembled electrical connectors. These connectors can be manufactured in specialized production facilities and then easily installed in an end product, in particular by latching them together. In addition, different configurations of connectors can also be manufactured in a simple way, which can then be optionally installed in an end product without making any changes to the end part itself before insertion.

It may be preferred to manufacture such connectors and connector systems from plastic, as this generally enables cost-effective and fast production. It also enables quick adaptation if requirements change, for example with regard to the geometry of the connector. However, it is known that the fit of such plastic connectors and connector systems is not always convincing. It can happen that the seat does not provide the resistance that it should according to the embodiment.

### SUMMARY

It is an object of the present invention to disclose an improved connector and connector system which provide a permanently reliable fit in a latched position, in particular such a fit as is intended to result from the constructive embodiment.

The object is achieved by a connector with a base body which encloses a cavity between a first opening and a second opening, wherein the base body is configured such that at least one cable can be guided through the first opening, the cavity and the second opening, wherein at least two bars are arranged on a circumference of the first opening, wherein a spring segment is arranged at least between two bars which are adjacent along the circumference and a total of at least two spring segments are present, wherein an outwardly pointing protrusion is arranged on each spring segment, wherein each spring segment is configured such that it deforms elastically inwards against a spring force when pressure acts on the protrusion from outside, so that the protrusion can displace inwards, and that it can displace the protrusion outwards by the spring force when the pressure is removed.

The inventors have worked intensively with the problem of why the fit of connectors and connector systems made of plastic does not always meet expectations. The inventors have thereby discovered that the problem does not lie in the plastic material itself, but in the typical manufacturing process, injection molding.

In the injection molding process, hot liquid plastic is injected into a mold and removed after a short cooling phase. Due to the material properties of plastic and the often complex shaping, there are often tensions within the plastic which can be increased by the cooling process. The inventors have found that this tension can lead to changes in the actual desired shape. Such a change can also result from subsequent temperature fluctuations or ageing of the plastic.

This can also affect the latching geometry. Depending on the change in shape caused by the stresses, this in turn can lead to the connector or connector system having a suboptimal latching fit and offering less resistance to loosening of the connection.

The inventors have further found that one problem is that the detent or protrusion does not always sit exactly in the expected position. In particular, if the overlap between the protrusion and the corresponding recess in the connector system is reduced, the detent seat can come loose more easily.

The connector shown here is designed such that, on the one hand, deformations of the connector that could influence the desired position of the protrusion of the latching connection are counteracted, but, on the other hand, there is a sufficiently large possibility of displacement of the protrusion during insertion so that, in the inserted state, the largest possible contact surface can be achieved between the protrusion and the corresponding recess in the connector system. The spring segments are separated from the circumference of the first opening, in particular by a gap or recess. This enables good flexible displaceability.

In an exemplary embodiment, a spring segment is arranged between all bars which are adjacent along the circumference.

Again, a protrusion pointing outwards is arranged on each spring segment. The resulting arrangement enables a good snap fit.

In a further exemplary embodiment, distal ends of the bars and at least two spring segments form a closed shape enclosing an virtual continuation of the first opening.

The closed shape in the circumferential direction holds the spring segments and thus also the protrusions well in the desired position.

In a further exemplary embodiment a first cross-section of the first opening coincides with a second cross-section of a further opening which lies in one plane in which the spring segments lie.

This enables a simple implementation for insertion into a counterpart.

In a further exemplary embodiment at least two protrusions of two spring segments are opposite each other with respect to a center axis of the first opening.

This embodiment enables a good snap fit.

In a further exemplary embodiment the spring segments form a closed ring.

The formed ring holds the spring segments and thus also the protrusions well in the desired position. The ring can be circular or oval and can also comprise straight segments.

In a further exemplary embodiment three, four or five bars are arranged equidistantly along the circumference of the first opening.

For certain shapes of the opening, this embodiment may offer an advantageous arrangement, also for the resulting arrangement of the spring segments.

In a further exemplary embodiment the protrusion comprises an inclined contact surface which is configured to press the protrusion inwards with increasing force when the connector is inserted into a receptacle.

This enables easy insertion with simultaneous secure snap fit.

In a further exemplary embodiment the first opening comprises a cross-section with a normal vector, wherein the bars extend at an angle of at most 20°, or at most 10°, or at most 5°, or the bars extend at least approximately parallel to the normal vector.

This embodiment enables a simple snap fit connection. The angle should be considered starting from a center axis of the first opening. If the first opening is rounded, the angle is thus considered in the radial direction.

In a further exemplary embodiment a ratio of a first width of the spring segments in the circumferential direction to a second width of the protrusions in the circumferential direction is at least 2, at least 3, or at least 4.

This exemplary ratio has proven to be advantageous in some practical tests. In particular, only the width in which the protrusion has the maximum outward extension is taken into account for determining the width of the protrusion. Depending on the shape of the first opening, the ratio can also be at least 5, at least 7 or at least 10.

In a further exemplary embodiment a ratio of a total width of all bars in the circumferential direction to the circumference is at least 3, at least 5, or at least 7.

This exemplary ratio has proven to be advantageous in some practical tests.

According to a further aspect, the object is achieved by a connector system comprising a connector as described above and a receptacle configured to receive the connector, wherein the receptacle comprises a recess which forms a latching connection in interaction with the protrusion.

This connector system provides a good snap fit for the connector. Thereby, the receptacle receives the connector in particular in a positive locking manner, whereby a snap fit with little play can be achieved.

It is understood that the features mentioned above and those to be explained below can be used not only in the combination indicated in each case, but also in other combinations or on their own, without going beyond the scope of the present invention.

### BRIEF DESCRIPTION OF THE DRAWINGS

Exemplary embodiments of the invention are illustrated in the drawing and will be explained in more detail in the following description. The figures show:

FIG. 1 an assembled connector with a connector according to a first exemplary embodiment;

FIG. 2 the connector according to the first embodiment;

FIG. 3 a connector system with the connector according to the first embodiment before insertion into a receptacle;

FIG. 4 the connector system with the connector according to the first embodiment after insertion into the receptacle;

FIG. 5 a second exemplary embodiment of a connector;

FIG. 6 a top view of the second embodiment; and

FIG. 7 a side view of the second embodiment.

### DETAILED DESCRIPTION OF EXEMPLARY EMBODIMENTS

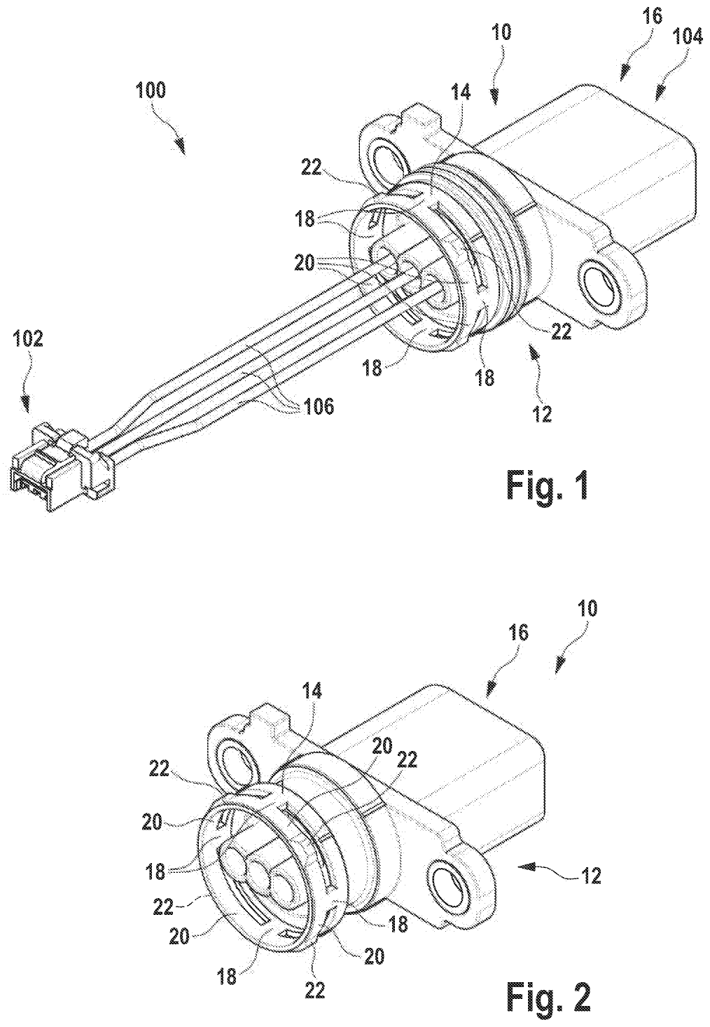

FIG. 1 shows an assembled connector 100 with a connector 10 according to a first embodiment. The connector 100 has a first connecting side 102 and a second connecting side 104, wherein there is an electrical connection between the connecting sides 102, 104 via a plurality of cables 106. The cables 106 are led out of a base body 12 of the connector 10, which encloses a cavity between a first opening 14 and a second opening 16.

The base body 10 is configured such that at least one cable 106, in this case several cables 106, can be led through the first opening 14, the cavity and the second opening 16. At least two bars 18 are arranged at a circumference of the first opening 14, wherein at least one spring segment 20 is arranged between two bars 18 that are adjacent along the circumference. In total, at least two spring segments 20 are present.

A radially outwardly pointing protrusion 22 is arranged on each spring segment 20, and each spring segment 20 is configured such that it deforms elastically inwardly against a spring force when pressure is acting on the protrusion 22 from the outside is applied, so that the protrusion 22 can displace inwardly, and that it can return to its original shape and displace the protrusion 22 outwardly by the spring force when the pressure is removed.

In this embodiment, a spring segment 20 is arranged between all bars 18 that are adjacent along the circumference. This means that for the four bars 18 shown, there are also four spring segments 20. The distal sections of the bars 18, that is, i.e., the sections farthest from the first opening 14, and the spring segments 20 form a closed shape enclosing a virtual continuation of the first opening 14.

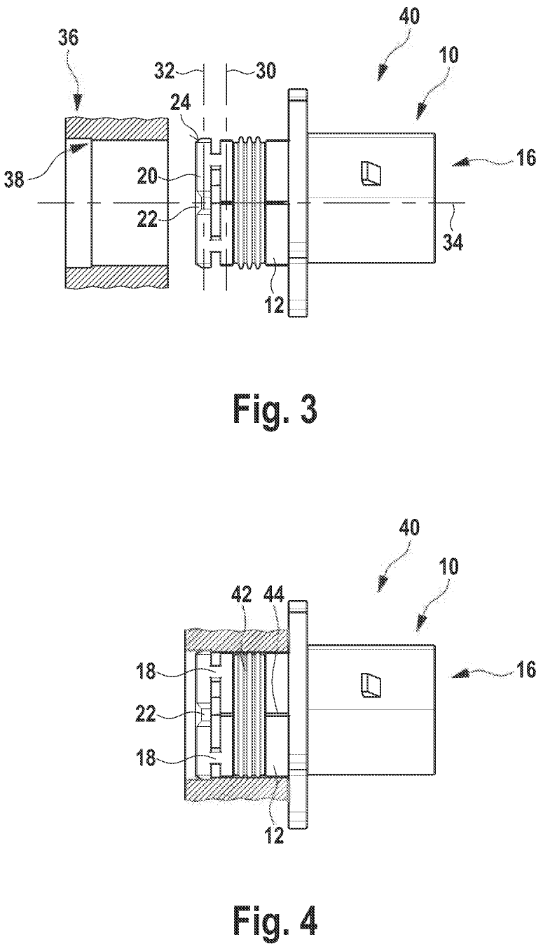

A first cross-section of the first opening, symbolized by the dashed line with the reference sign 30 in FIG. 3, coincides with a second cross-section of a further opening lying in one plane in which the spring segments lie, symbolized by the dashed line with the reference sign 32 in FIG. 3. At least two protrusions 22 of two spring segments 20 lie opposite each other with respect to a central axis 34, symbolized in 3, of the first opening, here for example the protrusion 22 in the position between 10 and 11 o'clock and the protrusion 22 in the position between 4 and 5 o'clock.

The spring elements 20 form a closed ring. The four bars 18 are arranged equidistantly along the circumference of the first opening 14. As can be seen particularly clearly from FIG. 3, each of the protrusions 22 comprises an inclined contact surface 24 which is configured to press the protrusion 22 inwards with increasing force when the connector 10 is inserted into a receptacle 36 (see FIG. 3), i.e. in the direction of the center axis 34.

The first opening 14 comprises a cross-section with a normal vector, which coincides with the center axis 34. The bars 18 extend at least approximately parallel to the normal vector. A ratio of a first width of the spring segments 22 in the circumferential direction, i.e. between the bars 18, to a second width of the protrusions in the circumferential direction is approximately 5.

FIG. 2 shows the connector 10 according to the first embodiment in a singled out view. All the explanations given above apply.

FIG. 3 shows a connector system 40 with the connector 10 according to the first embodiment before insertion into a receptacle 36, which is shown in sectional view and has a cylinder-like shape. The receptacle 36 is configured to receive the connector 10, wherein the receptacle 36 comprises a recess 38 which, in operational interaction with the protrusion 22, forms a snap fit connection, see FIG. 4.

FIG. 4 shows the connector system 40 with the connector 10 according to the first receptacle after insertion into the receptacle 36. It can be seen that a seal 42 seals the connector 10. Furthermore, small material protrusions 44 are shown, which support a centered insertion and a fit in the receptacle 36 that is as free from play as possible.

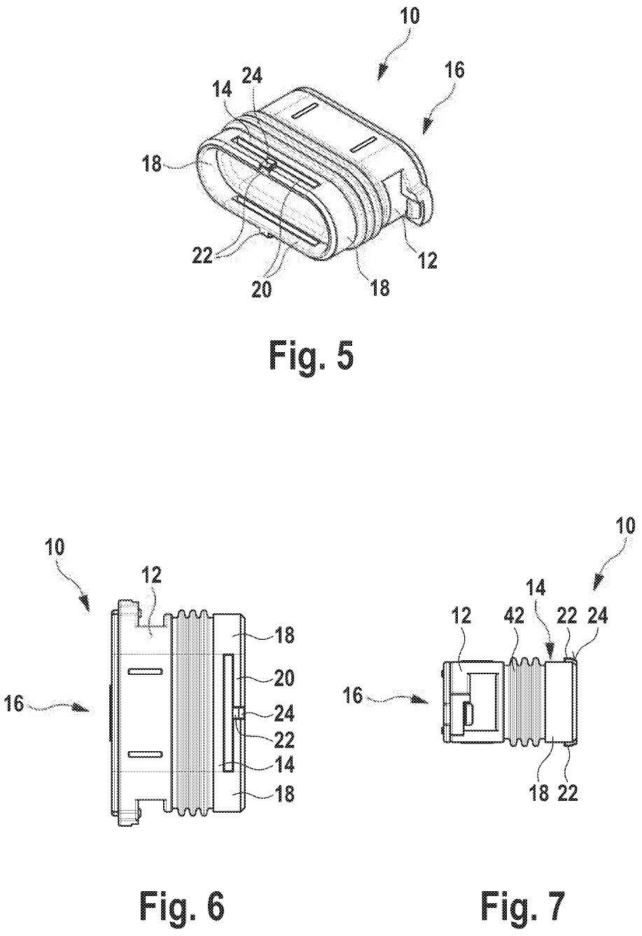

FIG. 5 shows a second embodiment of a connector 10. The reference signs introduced so far continue to be used for members having the same function. It can be seen that the bars 18 each form approximately a semicircle and the spring segments 20 are configured in a straight line.

FIG. 6 shows a top view of the second embodiment.

FIG. 7 shows a side view of the second embodiment.

What is claimed is:

1. A connector comprising:
a base body which encloses a cavity between a first opening and a second opening, wherein the base body is configured such that at least one cable can be guided through the first opening, the cavity and the second opening, wherein at least two bars are arranged on a circumference of the first opening, wherein a spring segment is arranged at least between two bars which are adjacent along the circumference and a total of at least two spring segments are present, wherein an outwardly pointing protrusion is arranged on each spring segment, wherein each spring segment is configured such that it deforms elastically inwards against a spring force when pressure acts on the protrusion from outside, so that the protrusion can displace inwards, and that it can displace the protrusion outwards by the spring force when the pressure is removed.

2. The connector according to claim 1, wherein a spring segment is arranged between all bars which are adjacent along the circumference.

3. The connector according to claim 1, wherein distal ends of the bars and at least two spring segments form a closed shape enclosing an imaginary continuation of the first opening.

4. The connector according to claim 1, wherein a first cross-section of the first opening coincides with a second cross-section of a further opening which lies in one plane in which the spring segments lie.

5. The connector according to claim 1, wherein at least two protrusions of two spring segments are opposite each other with respect to a center axis of the first opening.

6. The connector according to claim 1, wherein the spring segments form a closed ring.

7. The connector according to claim 1, wherein three, four or five bars are arranged equidistantly along the circumference of the first opening.

8. The connector according to claim 1, wherein the protrusion comprises an inclined contact surface which is configured to press the protrusion inwards with increasing force when the connector is inserted into a receptacle.

9. The connector according to claim 1, wherein the first opening comprises a cross-section with a normal vector, wherein the bars extend at an angle of at most 20°.

10. The connector according to claim 1, wherein a ratio of a first width of the spring segments in the circumferential direction to a second width of the protrusions in the circumferential direction is at least 2.

11. The connector according to claim 1, wherein a ratio of a total width of all bars in the circumferential direction to the circumference is at least 3.

12. A connector system comprising a connector according to claim 1 and a receptacle configured to receive the connector, wherein the receptacle comprises a recess which forms a latching connection in interaction with the protrusion.

13. An electrical connector comprising:
a base body with a first opening, a second opening and a cavity;
the first opening having a closed ring of spring elements each separated by a bar, the closed ring located on a circumference of the first opening, the closed ring separated by spaces between the spring elements and the base body;
a plurality of outwardly pointing protrusions, one of the plurality of outwardly pointing protrusions arranged on each spring element, wherein each spring element is configured such that the spring element deforms elastically inwards against a spring force when pressure acts on the protrusion, so that the protrusion can displace inwardly, and the spring element can displace the protrusion outwards by the spring force when the pressure is removed.

14. The electrical connector of claim 13, wherein the first opening, the second opening and the cavity are configured to receive at least one wire therethrough.

15. The electrical connector of claim 13, wherein the electrical connector is configured to be inserted into a receptacle, the receptacle causing the elastic deformation of the spring elements.

16. The electrical connector of claim 13, wherein the first opening is circular.

17. The electrical connector of claim 13, wherein the second opening is rectangular.

18. The electrical connector of claim 13, wherein each bar and each spring element is located on an outer surface of the first opening.

19. The electrical connector of claim 13, further comprising a seal and at least two protrusions of two spring elements lie opposite each other with respect to a central axis of the electrical connector.

20. The electrical connector of claim 13, wherein each bar extends along a longitudinal axis of the electrical connector.
